(19) United States
(12) Patent Application Publication
(10) Pub. No.: US 2008/0228537 A1
(43) Pub. Date: Sep. 18, 2008

(54) Systems and methods for targeting advertisements to users of social-networking and other web 2.0 websites and applications

(76) Inventors: Andrew Monfried, Norwood, NJ (US); Doug Pollack, Baltimore, MD (US); Jeremy Pinkham, Ellicott City, MD (US); Devin Rust, Boise, ID (US)

Correspondence Address: DAY PITNEY LLP, 7 TIMES SQUARE, NEW YORK, NY, 10036-7311, US

(21) Appl. No.: 11/977,045

(22) Filed: Oct. 22, 2007

Related U.S. Application Data
(60) Provisional application No. 60/903,500, filed on Feb. 26, 2007.

(51) Int. Cl. G06Q 30/00

(52) U.S. Cl. 705/7

(57) ABSTRACT

The present inventions manage and deliver electronic advertisements to targeted users of an electronic communication network. The present inventions target advertisements based on the user's interactions with or behaviors exhibited on sites within the communication network. The present inventions also define audiences of target users based on the users' interaction with or behaviors on the sites and/or their responses to advertisements.

### CROSS-REFERENCE TO RELATED APPLICATIONS

This specification is based on and claims priority to U.S. Patent Provisional Application Ser. No. 60/903,500, filed Feb. 26, 2007, which is incorporated herein by reference in its entirety.

### BACKGROUND OF THE INVENTION

1. Field of the Invention

The present inventions described herein relate to the management and delivery of electronic advertisements in an electronic communication network. The present inventions relate to targeting to a user of the communication network specific advertisements based on that user's activities in the communication network. The present inventions accomplish targeting by segmenting the users based on their interaction with the network and their responses to advertisements.

2. Description of the Related Art

Electronic communication networks such as the Internet and mobile telephone networks allows for mass exchange of information and data. For example, many users of such networks can retrieve from websites news or stock information or have news or stock reports sent to their mobile computing devices. Those networks have facilitated the explosive growth of e-commerce opportunities such as advertising. As users view web pages or receive data, the users sometimes must view advertisements on the web pages or embedded in the data messages.

Advertising on electronic communication networks encompasses many different techniques that place an advertisement in front of a desired audience. That is to say, the advertisements seen by one person may not be the same as those seen by another person when viewing the same website or receiving the same data message. Most techniques begin with companies, ad agencies and other advertisers developing an advertisement targeting campaign, i.e., they develop a target audience to whom they want to direct an advertisement. In print media, advertisers base that decision on a number of factors such as the readership of a print publication and subject matter of that publication. For example, an advertiser is more likely to place an advertisement for hand tools in a home remodeling magazine than in a teenage fashion magazine.

On electronic communication networks, a variety of techniques have been used to implement advertisement targeting campaigns. Since the electronic communication networks contain lots of data, many advertisers use some type of ad serving technology that is based on that data. In some cases, the ad server will target an advertisement based on the content of a web page or a data message that was viewed by a user. That process is sometimes referred to as contextual advertising. For example, a network user, who is viewing a web page or data message regarding automobiles on or from NYTimes.com, may see an advertisement for a car or auto parts. Another example is a network user, who is viewing a page or data message regarding fashion on or from Vogue.com, may see an advertisement for a clothing store.

In other cases, the ad server will target an advertisement based on the content of cookies stored on a user's computer. For example, if a cookie indicates a network user has visited several websites relating to automobiles, then, when that user visits any website that wants to display to that user an advertisement, the advertisement selected may be a car advertisement.

In all of the above mentioned examples, the advertisement targeting campaigns take advantage of demographic or other data stored on a website, on the communication network or on a network user's computing device.

The advent of social-networking websites, such as Facebook.com and Myspace.com, and other Web 2.0 websites and applications has presented new challenges for electronic advertisers. Those applications and websites provide platforms for their users' content. In other words, those applications and websites are generally considered tools and not content providers or publishers such as NYTimes.com or search engines like Yahoo.com or Google.com. Some of the characteristics of those applications and websites are: applications/websites encourage its users to add value to the applications/websites by posting to the applications/websites; users of the applications/sites own their content that they post; and social networking tools such as grouping users based on user profiles or selections.

As mentioned above, advertisers target advertisements to a website's user based on the content of the page that the user viewed. For example, a user of NYTimes.com, who is viewing car classifieds, may be presented a car advertisement since that user has expressed an interest in car classifieds. Similarly, a user of Google.com who searches for infant car seats may be presented an infant car seat advertisement since that user has expressed an interest in that product. In both of the aforementioned cases, the websites own the content that the user is viewing or searching on and, thus, is able to easily target advertisements based on that content.

Social networking and other Web 2.0 applications and websites, however, usually do not own the content on their applications or websites—the users do—which means the applications and websites are unable to harvest the content to target advertisements. In addition, the web pages on social networking and other similar sites often dynamically change and the web pages for a user of a social networking or other similar site may also contain content that relates to many different and un-related subject matters. In addition, users of those websites and applications often view lots of pages during each session, and the characteristics of those users often do not match the content located on the website pages viewed by the user. The viewing habits of a users also do not necessarily correlate with the user's interests or the context of the page viewed by the user. In the end, those websites and applications, which can be high volume sites and applications, do not allow for easy identification of users for advertisement targeting purposes. Therefore, in order to target advertisements to those users, those websites and applications need a method to capture the interests of its users and to provide a basis to target advertisements.

### SUMMARY OF THE INVENTION

The present inventions solve the aforementioned problems by focusing on people targeting instead of page targeting used in other traditional ad serving-related applications such as contextual relevance targeting. Two concepts that form the basis of present inventions are: Behaviors and Audiences. Behaviors are actions that users take such as actions on a web page in a social community website. The behaviors are not, for example, a user passively reading a web page; behaviors are the ways a user actively interacts with the web page. Audiences refers to a method of judging a user's response to an advertisement against the behaviors associated with that user to determine how a segment of users, i.e., an audience, will consume the advertisement.

An object of the present inventions is to target user of sites and applications on an electronic communication network an advertisement. The present inventions collect data regarding the user's behaviors on the sites and applications. The present inventions define an audience of targeted users for an advertisement based on one or more user behaviors such as editting a blog entry. The present inventions can optimize the audience definition based on the audience user's conversions of advertisements. The present inventions compare the user's behaviors with the behaviors in the target audience definition and determine whether the user has displayed pre-selected behaviors in the target audience definition. If the user has displayed pre-selected behaviors in the target audience definition, then the present inventions will cause an advertisement intended to be presented to users in the audience to be sent to the user.

Another object of the present inventions is the present inventions collect data from a tag on the site or application or from a database of previously collected data.

Another object of the present inventions is the present inventions define the audience based on pre-selected user behaviors.

Another object of the present inventions is the present inventions defines the audience based on user behaviors that the user and other users of a site or application have displayed.

Another object of the present inventions is the present inventions select the behaviors for an audience definition from the user behaviors that the user and other users of a site or application have displayed by applying Pearson's Correlation Coefficient to the user behaviors that the user and other users have displayed.

Another object of the present inventions is the present inventions define the audience based on the user behaviors that the user and other users of a site or application have displayed and that will produce an optimal response to an advertisement.

Another object of the present inventions is the present inventions determine the user behaviors that will produce an optimal response to an advertisement by performing a regression analysis on the user behaviors that the user and other users have displayed.

Another object of the present inventions is the present inventions determine whether the user has displayed pre-selected behaviors in the target audience definition by applying Pearson's Correlation Coefficient to the user's behaviors and the behaviors in the target audience definition.

Another object of the present inventions is the present inventions is to implement the present inventions in a computer(s) on an an electronic communication network(s).

### BRIEF DESCRIPTION OF DRAWINGS

The accompanying drawings illustrate the inventions described herein and, together with the Detailed Description below, help to describe the inventions. The reference numerals in the drawings refer to the same or like elements and are used in the Detailed Description to refer to the same or like elements. Below are brief descriptions of the drawings:

FIG. 1 is a network diagram in accordance with an embodiment of the present inventions;

FIG. 2 is a flow chart illustrating data collection and advertisement targeting processes in accordance with an embodiment of the present inventions;

FIG. 3 is a chart of sample data collected and used by the data collection and advertisement targeting processes in accordance with an embodiment of the present inventions;

FIG. 4 is another chart of sample data collected and used by the data collection and advertisement targeting processes in accordance with an embodiment of the present inventions;

FIG. 5 is a flow chart illustrating advertisement targeting processes in accordance with an embodiment of the present inventions;

FIG. 6 is a network diagram in accordance with an embodiment of the present inventions;

FIG. 7 is a chart of sample data collected and used by the data collection and advertisement targeting processes in accordance with an embodiment of the present inventions; and

FIG. 8 is another chart of sample data collected and used by the data collection and advertisement targeting processes in accordance with an embodiment of the present inventions.

### DETAILED DESCRIPTION OF THE PREFERRED EMBODIMENTS

The present inventions will target advertisements to users of social networking, community and other Web 2.0 applications and websites (hereinafter referred to as “social websites”) in an electronic communication network. Most ad targeting techniques utilize the content of websites or data collected from a variety of sources such as cookies on a user's computer. The content of social websites, however, is dynamic and is not a good source of information for ad targeting. For example, a user of a social website such as Myspace.com may set up a web page that contains content posted by the user. The user can modify the content at any time and can also post content related to a multitude of potentially un-related topics. As a result, since the content may always be changing and may relate to more than one broad subject matter area, most advertisement targeting techniques can not target advertisements to users who view the Myspace.com web page.

The present inventions, however, can target advertisements to a user of a social website on an electronic communication network. The present inventions base advertisement targeting on actions that the user took or behaviors that the user exhibited while using the social websites. The present inventions can also target ads based on other collected data. In other words, the present inventions focus on the user and base advertisement targeting on the nature of a user's interaction with a social website instead of the content of the application or website. Below is a description of the present inventions that is broken down into the following sections:

(i) a description of the user actions or behaviors that the present inventions track,

(ii) a description of how the present inventions track such user actions or behaviors,

(iii) a description of how the present inventions may be implemented on an electronic communication network,

(iv) a description of how the present inventions can target to a user an advertisement based on the tracked actions or behaviors,

(v) a description of how the different processes of the present inventions may exchange data,

(vi) a description of sample data collected, analyzed and reported by the present inventions, and

(vii) a description of some features of the present inventions and some advantages of the present inventions over other prior advertisement targeting methods.

While the descriptions below illustrate the present inventions in connection with the Internet and social websites, one of skill in the art will understand the present inventions can be applied in other scenarios. For example, one of skill in the art will understand the present inventions can be applied to other electronic communication networks such as mobile telecommunication networks. One of skill in the art will also understand the present inventions can be applied to other websites and applications.

Behaviors

The present inventions track actions that a user took or behaviors that the user exhibited (hereinafter referred to as “behaviors”) while using a site or application on an electronic communication network, such as a social website. Behaviors are not the content of the web pages on a social website nor the navigational history of the user nor the demographic information about the user. Instead, behaviors are the ways in which the user interacts or engages with a social website and, thus, can be considered virtual user interactions. Below is a list of sample actions that a user can take on a social website:
Registered/Did not register
Provide demographics such as DOB and Gender
Signed In
Found Friends
Added Friends
Edited Profile
Added Movies
Added/uploaded Videos
Added Quiz
Added Widgets
Rated
Watched Videos
Chatted
Organized
Changed Skin
Changed Settings
Played Quiz
Sorted
Posted
Invited

Behaviors are not just actions; behaviors can be any type of data that can be normalized, including, for example, the interests exhibited by a user. Below is a list of sample interests that can be exhibited by a user:
Actors
News
Fun Stuff
Blogs & News
Photos
Skins
New Releases
Latest News & Gossip
Popular User Quizzes
Show Times
Meet Other Fans
In Theatre
On DVD
My Recommendations
Action & Adventure
Animation
Anime & Manga
   Behaviors can also be data such as media types:
Movies
Videos
Television

Tracking Behaviors

In order to take advantage of behaviors, the present inventions track a user's behaviors and collect data regarding a user's behaviors. The present inventions use several techniques to accomplish tracking and collecting behaviors. The tracking or data collection can occur at any time such as when a user is using a social website or a social website is requesting an advertisement to be served to the user.

One tracking technique starts with identifying all possible behaviors that can occur on a social website and converting each behavior into a tag or pixel. Next, the tags are placed on the web pages of the social website where the tags' behaviors will occur. For example, assume the behaviors to be collected are related to two forums: sports and movies. A tag for sports and a tag for movies are created. Each of those tags is then placed on appropriate web page. For example, the sports tag can be placed on web pages in the sports forum or on pages with links to sport sites. Similarly, the movies tag can be placed on web pages in the movies forum or on pages with links to local movie theater listings. Another tracking technique is to create tags that automatically determine the behaviors exhibited by a user. In this technique, the auto discovery tags are placed on the web pages of a social website. When a user of the social website activates a tag by visiting the web page, then the tag will trigger a process to determine the relevant behavior. The process may be located anywhere such as the process may be embedded in the tag, or the process may be a backend process that is located else where and is initiated by the tag being called. For example, assume the only behaviors that can be collected are related to two forums: sports and movies. The auto discovery pixel will perform pattern matching against the URL of the web page on which the auto discovery pixel is located and the URL used to call the tag to determine what behaviors are relevant. Thus, the tags will determine the two behaviors are the sports and movie forums. The tags can be configured to examine the web page on which they are located and to examine any supplemental data to which the tags are directed.

Another tracking technique is to create templates. Instead of creating tags that relate to a pre-defined behavior or that automatically determine a behavior, strings are associated with a particular behavior. As tags are activated, the present inventions will begin to create behaviors for each unique string value/behavior type combination that it receives.

All of the behavior tracking techniques will collect data about a user's behaviors and store the data in a profile about the user. The profiles do not contain any data that could be used to personally identify a user. The tracking techniques anonymously collect click-stream data whenever a tag is triggered. For example, the data collected may include a user's IP address, the date and time a website was visited, browser information and behaviors. Besides tracking behaviors of a user who is interacting with a social website, the present inventions can also track the behaviors of the owner of the web page with which the user has interacted. In addition the present inventions can track the behaviors of the user's friends or other users who are connected to the user in some fashion. In both cases, the present inventions will track the other user's behaviors and include in the user's profile information data about those other user's behaviors.

The present inventions may also track and collect in a user's profile other data about the user and the user's behavior. For example, the present inventions may store geographical or demographical data in the profile. The present inventions may also classify behaviors, such as a behavior is persistent if the behavior has been static for a user. Another example is a behavior may be classified as immediate, i.e., it was the most recent behavior by the user, or as indirect, i.e., a past behavior exhibited by the user.

In addition to tracking behaviors and other data, the present inventions will track users responses or conversions to advertisements.

Implementation on an Electronic Communication Network

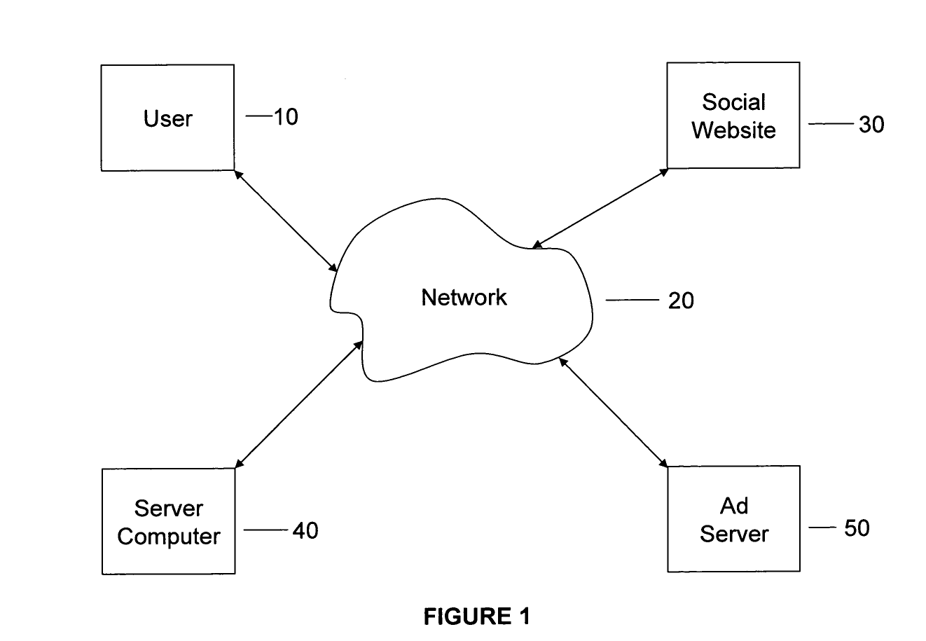

FIG. 1 illustrates an embodiment of the present inventions that can be used in electronic communication networks. The present inventions operate in a client-server fashion. A user 10 first accesses the communication network 20 from an access point. For example, if the network is the Internet, then the access point is an Internet browser. Next, the user 10 accesses a social website 30. As the user 10 interacts with the social website 30, the user 10 will activate behavior tracking tags located on the web pages of the social website 30. When a tag is triggered, the tag will communicate with the server computer 40. The server computer 40 then records the user's behavior that triggered the tag and creates or updates a profile for the user. The server computer may also mark the user with data regarding the tag and/or the behavior.

Next, when the user's interaction with the social website 30 or another website causes those sites to request an advertisement from ad server 50, the server computer 40 will determine the user falls within a segment of users who should receive targeted advertisements. If yes, then the ad server 50 will present to the user an advertisement that is targeted for that user's segment.

Targeting

The present inventions allow advertisement targeting campaigns to be based on behaviors and other collected data. A simple example is an ad campaign can direct advertisements to users who exhibit a specific behavior. When an advertisement is requested for a user, the present inventions will first determine what behaviors have been exhibited by the user. Next, the present inventions will send information about the user and the user's behaviors to an ad server. The ad server will select an advertisement based on the data received. The present inventions will then return the advertisement to the user and record data regarding the advertisement that was served to the user and the user's response or conversion of that advertisement.

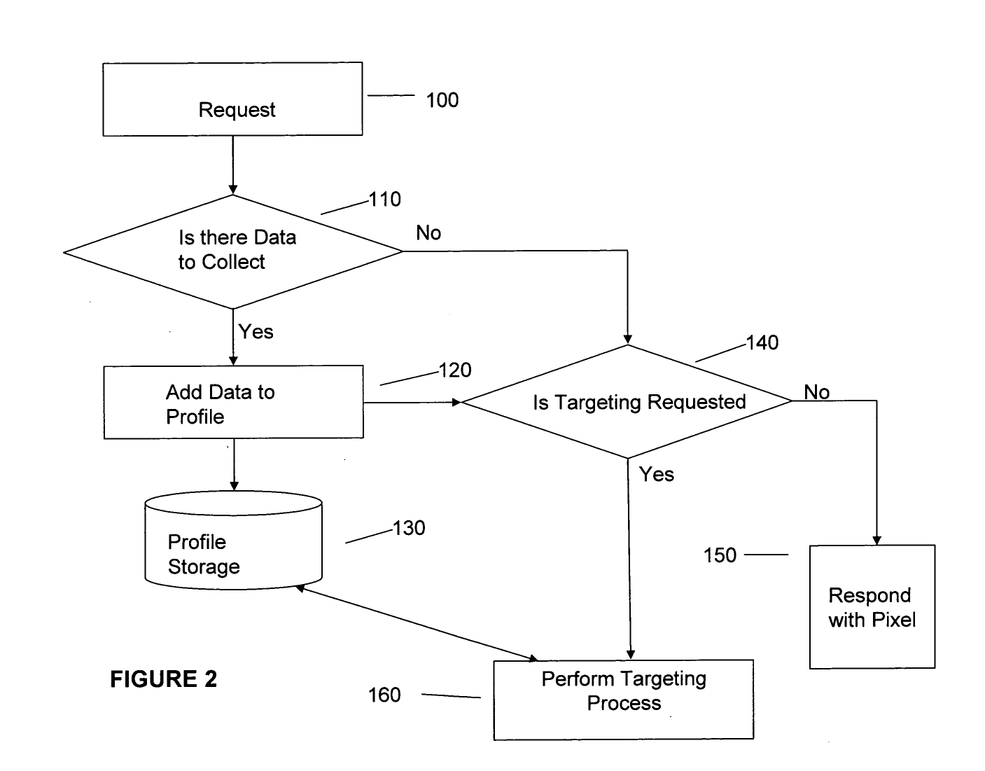

FIG. 2 illustrates steps that the present inventions can follow to target to users of a social website advertisements. The steps illustrated in FIG. 2 occur in the server computer 40. First, server computer 40 receives a request 100. At step 110, the server computer 40 determines whether it must collect data, such as behavior information from a tag that may have triggered the request, about the user for whom the advertisement is intended. If yes, then, at step 120, the server computer 40 will update a profile for the user that is stored in database 130.

After step 120 or if no data is to be collected at step 110, then, at step 140, the server computer determines whether it must request an advertisement. If the answer is no, then the server computer may return, for example, a response with no visible content such as a pixel. When an advertisement is not requested, then the present inventions assume the request was simply collecting data and any response should be invisible to the user. If the answer is yes, then, at step 160, the server computer 40 will perform a targeting process that involves identifying audiences or clusters of users and/or identifying target users. While performing the targeting process, step 160 may request from database 130 data regarding users and may also update user profiles stored in database 130.

The present inventions can identify which audiences or clusters of users will most likely respond to an advertisement. In other words, the present inventions identify an audience of target users for an advertisement.

One embodiment of the present inventions that identifies audiences of target users segments the users in an automated fashion based on the idea users who exhibit certain behaviors will interact with certain advertisements in the same fashion. That segmentation process, also known as clustering, uses Pearson's Correlation Coefficient to group together users that have exhibited similar behaviors. In other words, the process calculates the level of similarity between users based on the behaviors with which they have been tagged or which are stored in their profiles. From there, the users are grouped together into audiences.

The segmentation process begins with a review of a group of users and the users' behaviors. The users that are placed in the group can be selected based on any set of parameters such as they displayed pre-selected behaviors or they have other characteristics in common such as they all converted on an automobile advertisement.

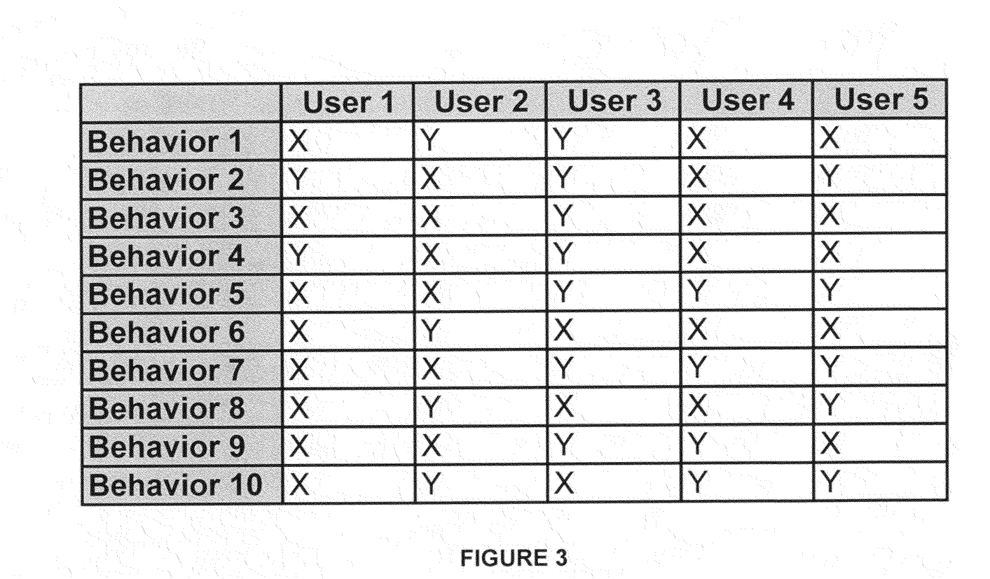

FIG. 3 illustrates a sample set of behavior data related to the users in such a group. In FIG. 3, the chart lists the users and the behaviors displayed by those users. “X” represents a behavior displayed by a user and “Y” represents a behavior not displayed by a user.

As used herein, “displayed” can be based on any data regarding whether a user exhibits or does not exhibit a specific behavior. For example, displayed can be based on frequency (i.e., the user has performed the behavior a minimum number of times), recency (i.e., the user has performed a behavior within a specific number of days) or a combination of both frequency and recency. Another example is displayed can be equal to the number of times the user has performed the behavior, i.e., X=the number of times a behavior was exhibited.

Next, the segmentation process analyzes the users' behaviors using Pearson's Correlation Coefficient to define a cluster of users that can be considered an audience. The analysis steps are:

Initially, compare one pair of users at a time, e.g., compare User 1 vs. User 2, using Pearson's Correlation Coefficient, which states:

$$r = \frac{n {\sum }_{i = 1}^{n} {x}_{ik} {x}_{im} - ( {\sum }_{i = 1}^{n} {x}_{ik} ) ( {\sum }_{i = 1}^{n} {x}_{im} )}{\sqrt{[ n {\sum }_{i = 1}^{n} {x}_{ik}^{2} - {( {\sum }_{i = 1}^{n} {x}_{ik} )}^{2} ] [ n {\sum }_{i = 1}^{n} {x}_{im}^{2} - {( {\sum }_{i = 1}^{n} {x}_{im} )}^{2} ]}}$$

where:
“r” is the coefficient being calculated,
“n” is the number of behaviors,
“i” is the index in the universe of all behaviors of the behavior being evaluated,
“k” is the index in the universe of all users of the first user being compared,
“m” is the index in the universe of all users of the second user being compared, and
“x” represents whether the user has the behavior. For example xᵢₖ is 0 if user k does not have behavior i, and is 1 if user K does have the behavior.

Next, calculate the distance between User 1 and User 2 based on their behaviors using the following formula:

Distance=1−r

Next, the above steps are recursive and are repeated until every combination of users (e.g., User 1 vs. User 3, User 1 vs. User 4, etc.) has been analyzed.

Next, the users with the smallest Distances are grouped together according to a predetermined spread. For example, users, who have Distances less than X, where X is a predetermined value, are grouped together.

Next, after the groups are made, determine which behaviors each group member has and define an audience based on those behaviors. For example, assume Users 3, 4 and 5 are in a group and, according to FIG. 3, they have Behaviors 5 and 6 in common. Based on FIG. 3, those Users each displayed Behavior 6 but did not display Behavior 5. Therefore, the result is an audience is defined as users that display Behavior 6 and do not display Behavior 5. Using that audience definition, the present inventions can serve to the users in that audience advertisements whose targeting campaign states those advertisements should be shown to that audience.

Another embodiment of the present inventions that identifies audiences of target users determines which combination of user behaviors will drive the highest response to, or performance for, a specific advertisement or group of advertisements and defines a target user based on that determination. The determination compares how each user responds to an advertisement based on a pre-selected performance metric(s). For example, the metrics(s) can be based on the behaviors with which a user has been tagged or behavior data stored in a user's profile such as a behavior that states the user converts advertisements for clothes.

The determination process performs the comparison with a regression analysis that determines which behaviors are significant to the audience model using optimization, p-values and an iterative process. Once a model is created, the behaviors that are significant to the model are labeled as either “the user in the audience should display this behavior” or “the user in the audience should not display this behavior”. If a behavior is not significant to the model, then a user can display or not display that behavior. Thus, the audience of target users is defined to be a user who displays certain behaviors and/or does not display other certain behaviors.

The determination process begins with a review of a group of user behaviors and a metric. The behaviors that are placed in the group can be selected based on any set of parameters such as they are pre-selected behaviors or they have other characteristics in common such as they all lead to conversions of an automobile advertisement. The metric can be any metric that one wants to use for comparing the behaviors or any metric against which one wants to optimize. Sample metrics include, for example, clicks, click through rate, conversions, conversion rate or time exposed to an ad.

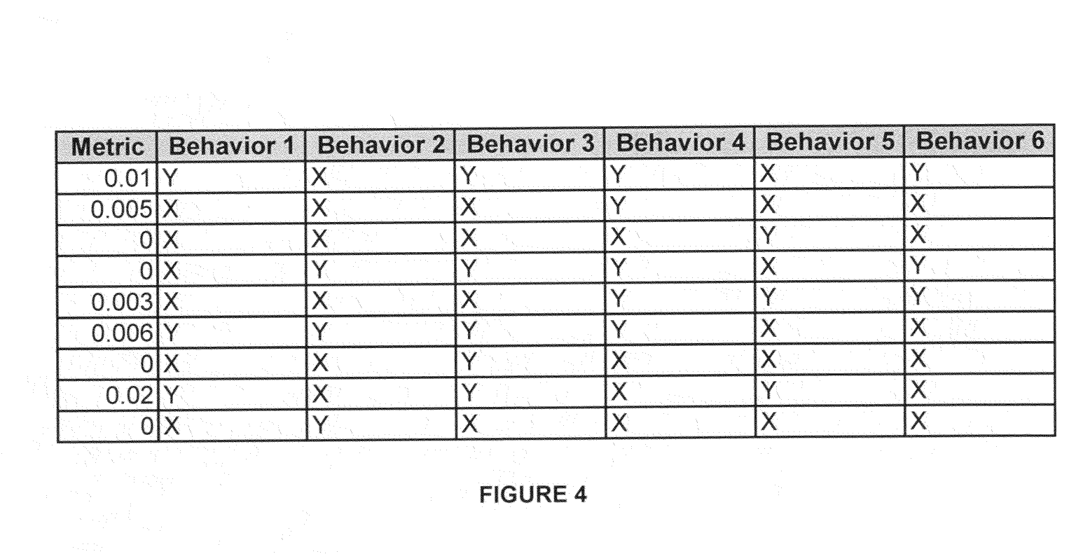

FIG. 4 illustrates a sample set of behavior data related to a pre-selected performance metric. In FIG. 4, the chart lists a number of performance metrics and behaviors. “X” represents a behavior that displayed a metric and Y represents a behavior that did not display a metric.

Next, the process analyzes the metrics and behaviors using a regression analysis to define a target user for an advertisement. The analysis steps are:

Initially, using the following formula:

Ŷᵢ=β₀+β₁X₁+β₂X₂+β₃X₃+β₄X₄+β₅X₅+β₆X₆+β₇X₇+β₈X₈

calculate Ŷᵢ for each user and optimize the β's by minimizing the ratio:
SSE/R²
   where:
“Y” is the metric,
“Ŷᵢ” is the predicted value for the metric,
“Yᵢ” is the actual value for the metric,
“SSE” is defined as Σ(Yᵢ−Ŷᵢ)²,
“R²” is the fraction of the total squared error explained by the regression 1-(SSE-SST), and
“SST” is defined as Σ(Yᵢ− Y̅)².

Next, analyze the β's by using p-values to determine if they are significant. The β with the highest p-value that is greater than 0.1 will be eliminated from the target user model along with the behavior that is represented by that β.

Next, the above steps are recursive and are repeated until all p-values greater than 0.1, and their corresponding behaviors, are eliminated from the model.

Next, once the model is defined, determine which behaviors a target user must have. For β's greater than 0, a user is a target user if that user displays the behavior(s) that corresponds to those β's. For β's less than 0, a user is not a target user if that user displays the behavior(s) that corresponds to those β's. Using that audience definition, the present inventions can serve to the users in that audience advertisements whose targeting campaign states those advertisements should be shown to that audience.

The present inventions can also determine, for users that do not exactly match an audience definition, whether those users are close enough to the definition to be considered a member of the audience. In such cases, the present inventions will follow the process outlined in the segmentation process described above to determine the distance between an audience definition and the user to whom an advertisement is to be served. The present inventions compare the determined distance to a pre-selected distance. If the determined distance is within the pre-selected distance, then the present inventions will serve to the user advertisements whose targeting campaign states those advertisements should be shown to those users within a pre-selected distance of the audience definition.

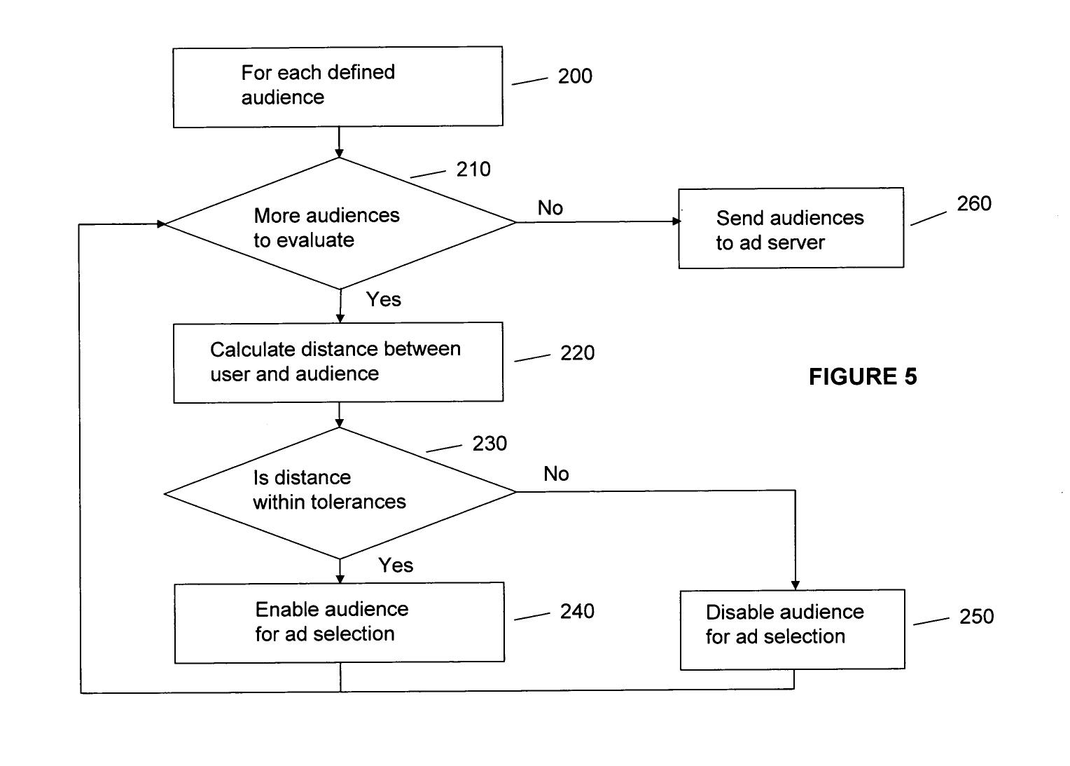

The present inventions can also perform the segmentation process with audience definitions in an iterative fashion. FIG. 5 illustrates an embodiment of the present inventions that examines a user's behaviors with which a user has been tagged or behaviors stored in a user's profile and determines whether the user falls within one or more audience definitions. The process outline in FIG. 5 can occur in the server computer 40.

The process begins at step 200, which states the process is repeated for a set of audience definitions. At step 210, the server computer 40 determines whether it needs to examine another audience definition. If yes, then, at step 220, the server computer 40 calculates the distance between the audience definition and the user's behaviors with which the user has been tagged or stored in the user's profile. Next, at step 230, the server computer 40 determines whether the calculated distance is within tolerances or a pre-selected distance. If yes, then at step 240, the server computer enables the audience definition to be used by, for example, an ad server to select an advertisement for that user. If the answer is no at step 230, then, at step 250, the server computer 40 disables the audience definition from being used for advertisement selection purposes. After steps 240 and 250, the server computer 40 returns to step 210. If no more audience definitions need to be examined, then, at step 260, the server computer 40 sends the enabled audience definitions to, for example, an ad server, which can then use the enabled audience definitions to select an advertisement.

Exchange of Data Between Processes

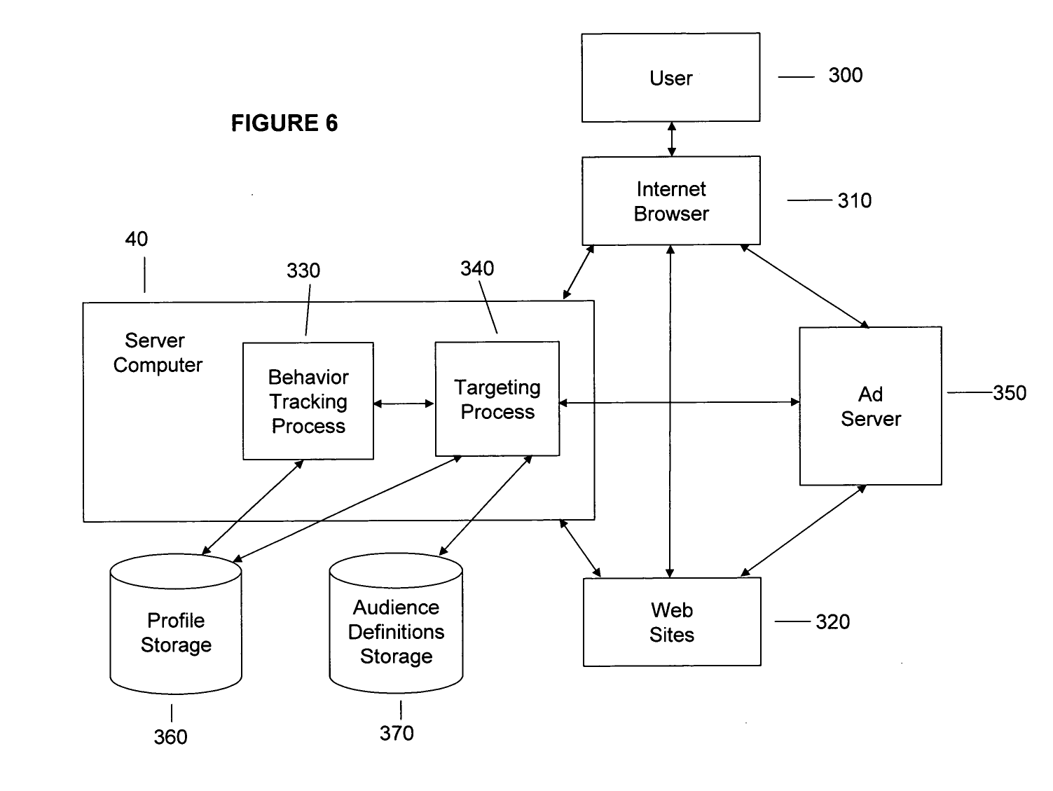

FIG. 6 illustrates how different processes used in the present inventions exchange information. User 300 interacts with social websites 320 through, for example, an Internet browser application 310. As user 300 interacts with social websites 320, tags on social websites 320 will cause behavior tracking process 330 in server computer 40 to collect data regarding the behaviors displayed by user 300 on social websites 320. Process 330 will also store in profile storage 360 data regarding those behaviors in a profile database record about user 300. Alternatively, process 330 can tag user 300 with data regarding those behaviors in, for example, a cookie stored on the user 300's computer.

In addition, as user 300 visits social websites 320, advertisement targeting process 340 will receive requests to serve to user 300 advertisements. In response to such requests, process 340 will, for example, perform the aforementioned targeting techniques to determine whether user 300 matches or is close to an audience definition. Process 340 will store data regarding audiences in storage 370. Process 340 will then send to ad server 350, which may be located inside or outside server computer 40, data regarding what audiences encompass user 300 and ad server 350 can use that data to determine what advertisement to serve to user 300.

After ad server 350 serves an advertisement, targeting process 340 will track user 300's responses or conversions to the advertisement and store data related to the response or conversion in storage 360. The next time targeting process 340 receives a request for an advertisement for user 300, process 340 can use the response data to develop optimized advertisement targeting strategies for user 300.

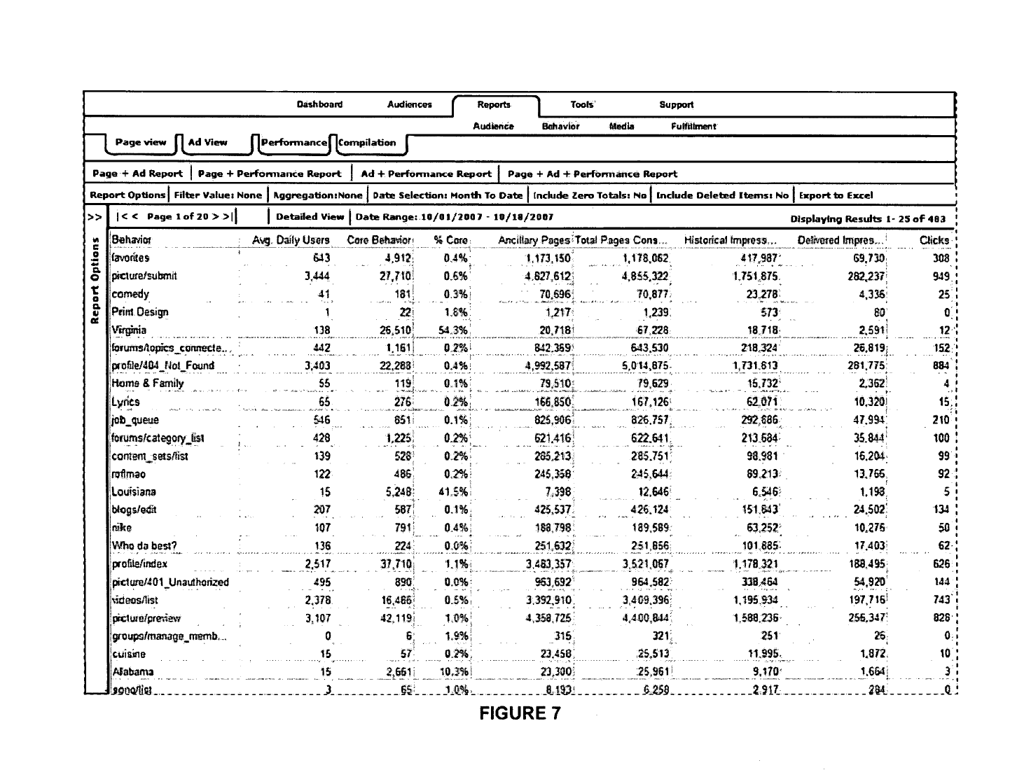

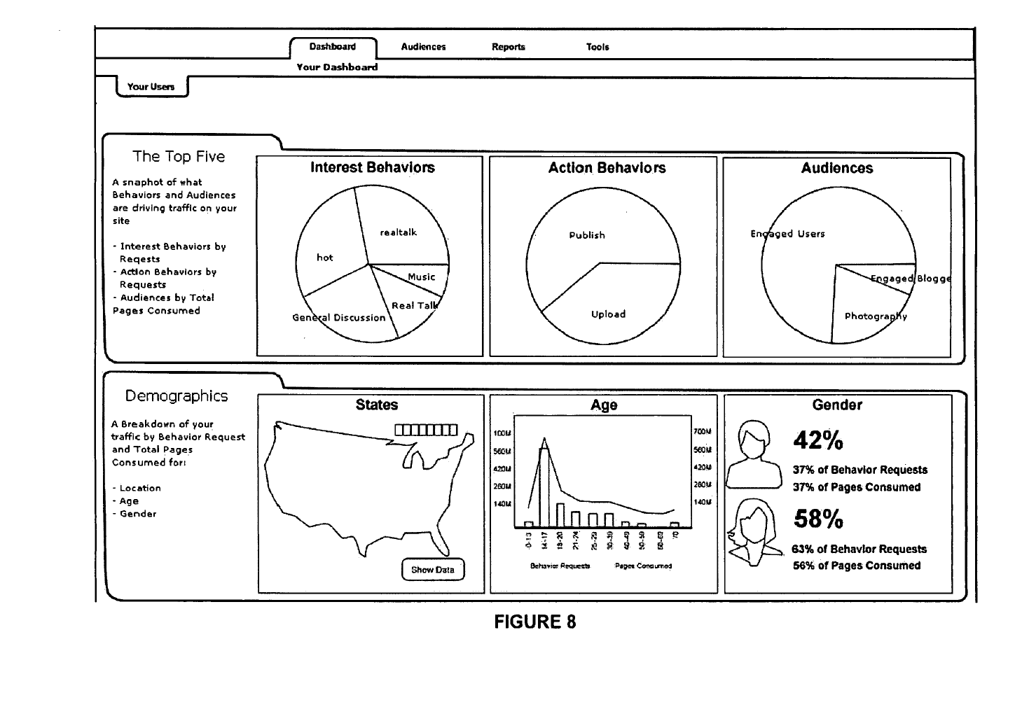

The present inventions can collect, analyze and report behavioral and other data. FIGS. 7 and 8 illustrate sample data collected by, and sample reports generated by, the present inventions.

FIG. 7 illustrates sample data generated by the present inventions based on users' interactions with a social website published a Client. Below are explanations of the columns and the data in each column:

The Behavior column lists the behavior or other data, such as interest, demographic or geographic data, that the present invention tracks for users.

The Average Daily Users column lists the number of users on the website, per day, on average.

The Core Behavior column lists the number of times an entry in the Behavior column was displayed. The number also represents the number of page views that triggered the Behavior.

The % Core column lists the percent of the Total Page Consumed that the Core Behavior represents. The % Core number is calculated as follows: Core Behavior/Total Pages Consumed.

The Ancillary Pages column lists the number of pages that a user, who displayed a Behavior, went on to consume or view on the social website after viewing the page that triggered the Behavior.

The Total Pages Consumed column lists the sum of the number in the Core Behavior column and the number in the Ancillary Pages column.

The Historical Impressions column lists the total number of impressions served. Impressions is the number of times an advertisement is served for viewing by a user. In other words, one impression is equivalent to one opportunity for a user to view an advertisement. The Delivered Impressions column lists the number of targeted impressions served by the ad server delivering advertisements in response to the Behaviors.

The Clicks column lists the number of times a user has clicked on a served advertisement.

The Client can use the data in the chart in FIG. 7 to develop advertising targeting campaigns. For example, the users of the Client's website, who displayed the Behavior “picture/submit,” went on to consume one of the largest number of Ancillary Pages. In addition, those users had the highest number of Delivered Impressions and Clicks. One way to interpret that data is the Client should target users with the Behavior “picture/submit” since those users present the Client with the greatest opportunity for serving advertisements that will be consumed or clicked on.

FIG. 8 illustrates sample data generated by the present inventions based on users' interactions with the Client's website. The Top Five section has three pie charts. The pie chart labeled “Interest Behaviors” shows, by interest classification, the behaviors that have the most request volume. The pie chart labeled “Action Behaviors” shows, by action classification, the behaviors that have the most request volume. The pie chart labeled “Audiences” shows the audiences that have consumed the most total pages and, thus, depending on the advertisement targeting strategy, can represent the best targeting opportunities.

The Demographics section in FIG. 8 displays location, age and gender information. The area labeled “State” shows a map that depicts a breakdown of where the users of the Client's website are physically located. The area labeled “Age” shows a bar chart that depicts a breakdown of the users by their ages and by both the total number of requests triggered by a behavior tracked by the Client and total number of targeting opportunities (or pages consumed). The area labeled “Gender” shows a breakdown of the users by gender and by both the total number of requests triggered by a behavior tracked by the Client and total number of targeting opportunities (or pages consumed).

As with FIG. 7, the Client can use the data in the chart in FIG. 8 to develop advertising targeting campaigns. For example, the Client can view the charts to determine what are the total targeting opportunities, i.e., the total actionable web page views where a particular audience is available for targeting. An opportunity can exist for an audience on a web page view in one of two ways: (1) Immediate—the current page the website user is viewing contains a behavior included in the audience, or (2) Indirect—a previous page viewed by the user contains a behavior included in that audience. Another example is the Client can view the charts to determine what are the total available inventories, i.e., the total actionable inventory where a particular behavior is available for audience discovery. A behavior can be available on a page view in one of two ways: (1) Immediate—the current page the website user is viewing contains the behavior, or (2) Indirect—a previous page viewed by the user contains the behavior.

Features and Advantages

Social website publishers can use the present inventions to develop advertisement targeting campaigns based on behavioral and other data tracked by the present inventions. One option that an advertiser has with the present inventions is the advertiser can pre-select behaviors displayed by a user, in response to which the advertiser wants to serve a specific advertisement. Another option is the advertiser can pre-select behaviors displayed by a user and other meta data, such as the geographical location of the user's IP address, as the targeting parameters. Another option is an advertiser can initially develop a campaign that targets users who are members of several, for example, 50, audiences. As the campaign proceeds, the present inventions can examine user responses to the advertisements in the campaign and compare those responses with the behaviors in the audience definitions. The present inventions can then examine that data for those users using the aforementioned targeting processes to determine what audiences or behaviors are providing the best response to the advertisement. The present inventions can also refine the audience definitions based on the examination of that data.

Social website publishers can also use the present inventions to track behaviors displayed by other users of their social websites. For example, the present inventions can track the behaviors of an owner of content posted on a social networking website. Another example is the present inventions can track the behaviors of the members of a community on a social website. The social website publisher can then use the data about the other users in combination with the data regarding users (i.e., surfers) of their social websites to develop advertisement targeting strategies using the present inventions.

The present inventions provide advantages over traditional advertisement targeting strategies. Many current advertisement targeting strategies are based on a user's location in a network such as the Internet. For example, if a user is on NYTimes.com and is reading an article in the Sports section, then the user has demonstrated an interest in sports and may be served an advertisement that is related to sports memorabilia. The present inventions, however, based ad targeting on a user's interactions with a social website (i.e., behaviors) and not on the content or location of the social website. The advantage of using behaviors as a targeting tool is a user will display behaviors on more than one social website. For example, a user may register with a variety of social websites whose subject matter are unrelated, e.g., NYTimes.com, MySpace.com, ESPN.com, Vogue.com, ThisOldHouse.com. While the content of those sites may not be similar, the behavior, i.e., registering, is similar across those sites and may be an indicator that the user is a good target for an advertisement.

Another difference between the present inventions and other advertisement targeting strategies is the time period between collecting data and serving an advertisement based on that data. In many current advertisement targeting strategies, ad servers will examine a web page that a user is viewing and serve an advertisement based on the content of that page. The present inventions, however, track a user's behaviors over time and stores data regarding those behaviors. As a result, the present inventions can target to that user an advertisement long after the user displayed certain behaviors. For example, a user may use the Internet only on weekends. Current advertisement targeting strategies are based on the web pages viewed by the user on a particular day of the weekend. The present inventions can target advertisements based on behaviors displayed by the user over time such as over the weekends in one month, one year or over several years.

Overall, the present inventions base advertisement targeting campaigns on users and not on the web pages viewed by users. As a result, the present inventions are well suited for use with social websites. Those websites usually contain content that is generated by the users of those websites. The owners of the websites do not publish the content and, therefore, do not know and sometimes do not own the content. As a result, since many current advertisement targeting strategies are based on the content of websites, the owners can not use those strategies. The present inventions, however, allow the owners to examine users' behaviors and to test advertising responses or conversions against those behaviors to develop advertisement targeting strategies. In addition, since behaviors can be displayed on any website, the present inventions allow publishers to track users' behaviors across any number of websites to develop advertisement targeting strategies.

The purpose of the foregoing description of the preferred embodiments is to provide illustrations of the inventions described herein. The foregoing description is not intended to be exhaustive or to limit the inventions to the precise forms disclosed. One of skill in the art will obviously understand many modifications and variations are possible in light of the above principles. The foregoing description explains those principles and examples of their practical application. The foregoing description is not intended to limit the scope of the inventions that are defined by the claims below.

1. A computer implemented method for targeting to a user of sites and applications on an electronic communication network an advertisement, comprising the steps:
collecting data regarding a user's behaviors,
defining an audience of targeted users for an advertisement based on user behaviors,
comparing the user's behaviors with the behaviors in the target audience definition, and
determining whether the user has displayed pre-selected behaviors in the target audience definition,
wherein, if the user has displayed pre-selected behaviors in the target audience definition, then causing an advertisement intended to be presented to users in the audience to be sent to the user.

2. A computer implemented method for targeting to a user of sites and applications on an electronic communication network an advertisement, comprising the steps:
collecting data regarding a user's behaviors,
defining an audience of targeted users for an advertisement based on user behaviors,
optimizing the audience definition based on the audience user's conversions or advertisements,
comparing the user's behaviors with the behaviors in the target audience definition, and
determining whether the user has displayed pre-selected behaviors in the target audience definition,
wherein, if the user has displayed pre-selected behaviors in the target audience definition, then causing an advertisement intended to be presented to users in the audience to be sent to the user.

3. The method of claim 1 or 2, wherein:
collecting data is collecting data from a tag on the site.

4. The method of claim 1 or 2, wherein:
collecting data is collecting data from a database of previously collected data.

5. The method of claim 1 or 2, wherein:
defining the audience is defining the audience based on pre-selected user behaviors.

6. The method of claim 1 or 2, wherein:
defining the audience based on user behaviors that the user and other users have displayed.

7. The method of claim 6, wherein:
selecting the behaviors for the audience definition from the user behaviors that the user and other users have displayed by applying Pearson's Correlation Coefficient to the user behaviors that the user and other users have displayed.

8. The method of claim 1 or 2, wherein:
defining the audience based on the user behaviors that the user and other users have displayed and that will produce an optimal response to an advertisement.

9. The method of claim 8, wherein:
determining the user behaviors that will produce an optimal response to an advertisement by performing a regression analysis on the user behaviors that the user and other users have displayed.

10. The method of claim 1 or 2, wherein:
determining whether the user has displayed pre-selected behaviors in the target audience definition is applying Pearson's Correlation Coefficient to the user's behaviors and the behaviors in the target audience definition.

11. A computer program product stored in a computer storage medium, comprising: a computer program configured, when executed by a computer, to target to a user of sites and applications on an electronic communication network an advertisement, by:
collecting data regarding a user's behaviors,
defining an audience of targeted users for an advertisement based on user behaviors,
comparing the user's behaviors with the behaviors in the target audience definition, and
determining whether the user has displayed pre-selected behaviors in the target audience definition,
wherein, if the user has displayed pre-selected behaviors in the target audience definition, then causing an advertisement intended to be presented to users in the audience to be sent to the user.

12. The program of claim 11, wherein:
collecting data is collecting data from a tag on the site.

13. The program of claim 11, wherein:
collecting data is collecting data from a database or previously collected data.

14. The program of claim 11, wherein:
defining the audience is defining the audience based on pre-selected user behaviors.

15. The program of claim 11, wherein:
defining the audience based on user behaviors that the user and other users have displayed.

16. The program of claim 15, wherein:
selecting the behaviors for the audience definition from the user behaviors that the user and other users have displayed by applying Pearson's Correlation Coefficient to the user behaviors that the user and other users have displayed.

17. The program of claim 11, wherein:
defining the audience based on the user behaviors that the user and other users have displayed and that will produce an optimal response to an advertisement.

18. The program of claim 17, wherein:
determining the user behaviors that will produce an optimal response to an advertisement by performing a regression analysis on the user behaviors that the user and other users have displayed.

19. The program of claim 11, wherein:
determining whether the user has displayed pre-selected behaviors in the target audience definition is applying Pearson's Correlation Coefficient to the user's behaviors and the behaviors in the target audience definition.
